(19) United States
(12) Patent Application Publication
(10) Pub. No.: US 2025/0206527 A1
(43) Pub. Date: Jun. 26, 2025

(54) STORAGE SYSTEM WITH CONTAINERS AND ACCESS FRAMES

(71) Applicant: AutoStore Technology AS, Nedre Vats (NO)

(72) Inventor: Florian Sattler, Graz (AT)

(21) Appl. No.: 18/851,611

(22) PCT Filed: Mar. 24, 2023
(86) PCT No.: PCT/EP2023/057588

§ 371 Date: Sep. 26, 2024

(30) Foreign Application Priority Data
Mar. 30, 2022 (NO) 20220389

(51) Int. Cl. B65G 1/04; B65G 1/137; B65G 61/00

(52) U.S. Cl. CPC B65G 1/0464; B65G 1/0492; B65G 1/1373; B65G 61/00

(57) ABSTRACT

The present invention relates to a storage system (2) comprising a first structure (10) comprising upright members (12), the upright members defining a volume of columns (15) provided between the upright members (12). The system (2) comprises a rail system (18) provided on top of the upright members (12). A plurality of storage containers (6; 106) are arranged in stacks (17) within the columns (15). One or more of the stacks (17) includes a plurality of access frames (20), each access frame (20) being positioned between storage containers (6; 106) within that stack, with a bottom of each access frame (20) resting on an underlying storage container (6; 106) and a top of the access frame supporting an overlying storage container (6; 106). Each access frame (20) is configured to provide a side opening (20a) and a bottom opening (20b) to allow a person (P) to reach an item (80) stored in an underlying storage container (6; 106) by reaching in via the side opening (20a) through the bottom opening (20b) of the access frame (20) and through the top opening (6a, 106a) of the underlying storage container (6; 106), wherein the plurality of access frames (20) are arranged in an alternating manner with consecutive storage containers (6; 106), each storage container (6; 106) being spaced from one above by an access frame (20), to provide a set of accessible storage containers in that stack where access is allowed to each of the underlying storage containers in that set.

### FIELD OF THE INVENTION

The present invention relates to a storage system for making product items stored in storage containers accessible to a person. The present invention also relates to a method for making product items stored in storage containers accessible to a person.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201, 301, 401 colliding with each other, the automated storage and retrieval system 1 comprises a control system 500 which typically is computerized and which typically comprises a database for keeping track of the storage containers 106.

NO344898 describes a storage system comprises a picking and/or supply station with a drawer device, where the drawer device comprises a storage container with a compartment for temporarily storing a product item to be picked from or supplied to the storage system. The drawer device is configured to be in a closed state or in an open state; where an person is prevented from accessing the compartment in the closed state and where the person is allowed to access to the compartment in the open state. Identification of the person may be required to open the drawer.

One object of the present invention is to allow a person to access the content of one or a plurality of storage containers.

More specifically, the object of the present invention is to allow the person to access the content directly from the one or plurality of storage containers.

### SUMMARY OF THE INVENTION

The present invention relates to a storage system comprising:
a first structure comprising upright members, the upright members defining a volume of columns provided between the upright members;
a rail system provided on top of the upright members; and
a plurality of storage containers arranged in stacks within the columns, each storage container having a top opening;
   wherein one or more of the stacks includes a plurality of access frames, each access frame being positioned between storage containers within that stack, with a bottom of each access frame resting on an underlying storage container and a top of the access frame supporting an overlying storage container, each access frame being configured to provide a side opening and a bottom opening to allow a person to reach an item stored in an underlying storage container by reaching in via the side opening through the bottom opening of the access frame and through the top opening of the underlying storage container, wherein the plurality of access frames are arranged in an alternating manner with consecutive storage containers, each storage container being spaced from one above by an access frame, to provide a set of accessible storage containers in that stack where access is allowed to each of the underlying storage containers in that set.

Hence, the person may put his/her hand through the side opening, the bottom opening and the top opening and pick the product item directly from the storage container.

In one aspect, the storage system comprises a container handling vehicle operating on the rail system, wherein the container handling vehicle comprises a lifting device which is configured for vertical transportation of one of the storage containers or the access frames within the storage columns and for horizontal transportation of one of the storage containers or the access frames above the rail system.

Hence, the storage containers to which access should be granted may be arranged and rearranged automatically by means of the container handling vehicle.

In one aspect, the storage containers and the frames each comprise a connection interface on an upper surface and wherein the lifting device of the container handling vehicle comprises a gripper that is configured to engage the connection interface such that the container handling vehicle is able to lift any of the storage containers or frames using the lifting device.

In one aspect, the access frame comprises a rectangular top portion and legs protruding downwardly from the rectangular top portion, wherein the top portion defines an upper stacking interface allowing a storage container to be stacked above the access frame.

In one aspect, the frame comprises four legs, each leg protruding downwardly from corners of the rectangular top portion.

In one aspect, the side opening is defined by an area between one side of the rectangular top portion and two of the downwardly protruding legs.

In one aspect, the bottom opening is defined by an area between the lower end of the downwardly protruding legs.

In one aspect, the access frame comprises cross members connected between lower ends of at least some of the downwardly protruding legs, wherein the bottom opening is defined by the lower ends of the downwardly protruding legs together with the cross members.

In one aspect, the access frame comprises three cross members arranged in a U-shaped configuration with its open end facing towards the side opening.

Hence, as there is no cross member at the side opening, the upper edge of the storage container is forming the lower part of the side opening. This will increase the area of the side opening without increasing the height of the access frame.

In one aspect, the lower end of the downwardly protruding legs together with the cross members are forming a rectangular bottom portion.

In one aspect, lower ends of the downwardly protruding legs defines a lower stacking interface allowing the access frame to be stacked above storage containers or other access frames.

In one aspect, access frames are stacked alternately with storage containers in one or more of the stacks, optionally all of the stacks, along one side of a volume defined by the structure.

In one aspect, side openings of access frames in a first row of stacks are aligned with each other in a horizontal direction.

In one aspect, as the access frames and the containers are stacked above each other, the side openings of access frames in a first row of stacks are also aligned with each other in a vertical direction.

In one aspect, the side openings of access frames in the first row of stacks are facing a access area which is accessible for a person.

In one aspect, each storage container comprises a base with four sides protruding upwardly from the base, wherein the top opening is defined by an upper edge of the four sides.

In one aspect, one side of the storage container has a height which is lower than a height of other sides, and wherein the one side of the storage container is aligned with the side opening when an access frame is stacked above the storage container.

Hence, the side opening may be further increased without increasing the height of the access frame.

In one aspect, the one side of the storage container is facing the access area.

In one aspect, the one side may be referred to as a front side, a person-facing side or a public-area facing side.

In one aspect, side openings of access frames in a second row of stacks are parallel with the first row of stacks, wherein the first row is adjacent to the second row and wherein the side openings of the access frames in the first row are facing away from the side openings of the access frames in the second row.

In one aspect, the side openings of the access frames in the second row of stacks are facing the access area to provide access for a person.

Hence, the storage containers and access frames in the first and second rows form a shelf from which product items can be picked directly from the respective storage containers via the access frames.

In one aspect, the access frame comprises at least one light to illuminate an interior of a storage container.

In one aspect, the storage system comprises a barrier for covering at least one of the stacks of storage containers and access frames during elevation of a storage container or access frame from the one stack and/or during lowering of a storage container or access frame into the one stack.

Hence, the barrier is protecting the person from accessing the storage containers and access frames during vertical movement of the storage containers and access frames. Preferably, the barrier is extending over a larger area than just the one stack.

In one aspect, the storage system comprises a control system for controlling the container handling vehicles.

In one aspect, the storage system comprises:
a second structure comprising upright members, the upright members defining a volume of columns provided between the upright members;
a plurality of storage containers stacked directly above each other in stacks within the columns;
   wherein the second structure is provide adjacent to the first structure;
   wherein the rail system is provided on top of the upright members.

The second structure may be the framework structure of a prior art storage system. Here, the storage containers are stacked directly above each other in the stacks, and hence, the content of the storage containers stacked in the stacks are not accessible for a person.

In one aspect, the control system of the storage system is integrated with, or is a part of, the control system of the automated storage and retrieval system.

The present invention also relates to a method for making product items stored in storage containers accessible to a person, wherein the method comprises the steps of:
stacking a first storage container into a column defined by upright members of a first structure;
stacking a first access frame directly above the first storage container;
stacking a second storage container directly above the first access frame;
stacking a second access frame directly above the second storage container;
allowing a person to reach an item stored in an underlying storage container by reaching in via the side opening through the bottom opening of the access frame and through the top opening of the underlying storage container.

In one aspect, the steps of stacking comprises the step of:
controlling a container handling vehicle to move horizontally on a rail system secured above the upright members;
controlling a lifting device of the container handling vehicle to stack the storage containers and the access frames into the first columns.

In one aspect, the method further comprises the step of:
controlling the container handling vehicle to retrieve storage containers and/or access frames stored in stacks within columns of a second structure located below the rail system.

In one aspect, the set of storage containers in one stack may comprise 2-12 storage containers, preferably 3-8 storage containers, even more preferred 3-6 storage containers.

According to the above, it is achieved a storage system in which access to the content of storage containers is achieved by a person moving along the stacks of storage containers and accessing frames. The stacks and accessing frames may be arranged and rearranged automatically by means of the container handling vehicles. The first structure of the storage system may be a part of a microfulfilment centre or warehouse. The second structure of the storage system may be a storage from which containers containing product items are moved to the first structure. When storage containers in the first structure are empty or near empty, they are returned either to the second structure or to a replenishment station. The person will typically not be able to access containers stacked in the second structure.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 illustrates an access system adjacent to an automated storage and retrieval system, wherein the rail system of the access system is integrated with, or a part of, the rail system of the automated storage and retrieval system.

FIG. 6 illustrates a perspective view of a prior art storage container adjacent to an access frame.

FIG. 7 illustrates a perspective side view of a person standing adjacent to the access system.

FIG. 8a illustrates a perspective top view of a person standing adjacent to the access system.

FIG. 8b is an enlarged view of the dashed box A of FIG. 8a.

FIG. 9a-9c illustrate alternative embodiments of the access frame.

FIG. 10 illustrates an alternative embodiment of an embodiment of a storage container on which the access frame of FIG. 9c is stacked.

FIG. 11 illustrates how the persons hand is used to pick a product item from a storage container via the access frame.

FIG. 12 illustrates an access station with columns containing storage containers and access frames are stacked in stacks adjacent to the access station.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

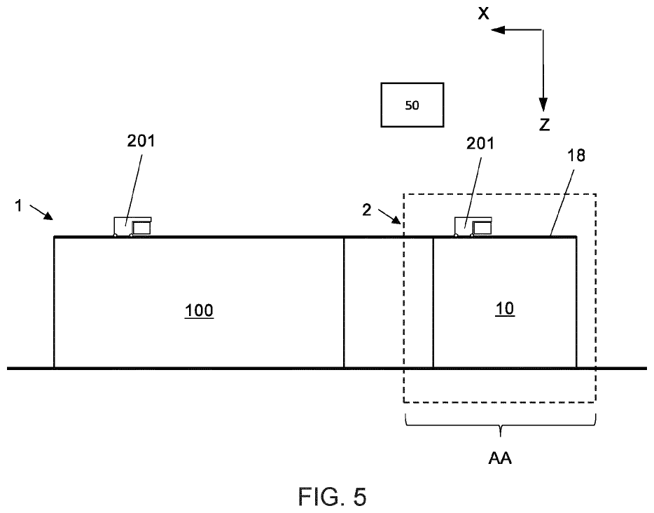

It is now referred to FIG. 5. Here, it is shown an automated storage and retrieval system 1 on the leftmost side of FIG. 5. The automated storage and retrieval system 1 may be of the prior art type described above, i.e. it comprises a framework structure 100 with a number of upright members 102 and storage compartments in the form of storage columns 105 provided between the members 102 wherein storage containers 106 are stackable in stacks 107 within the storage columns 105.

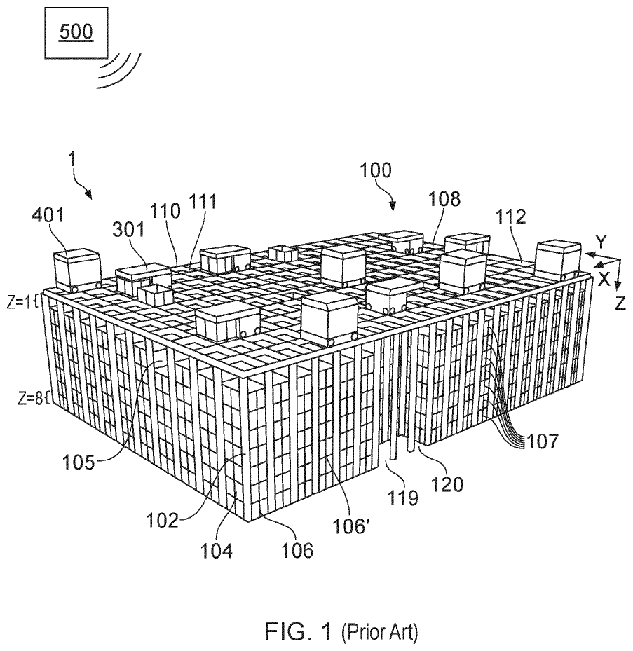

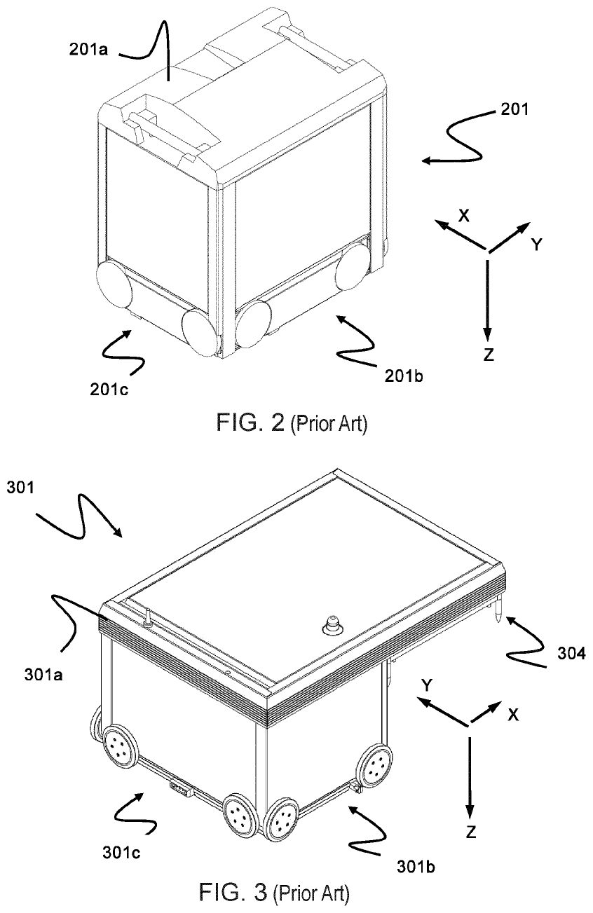

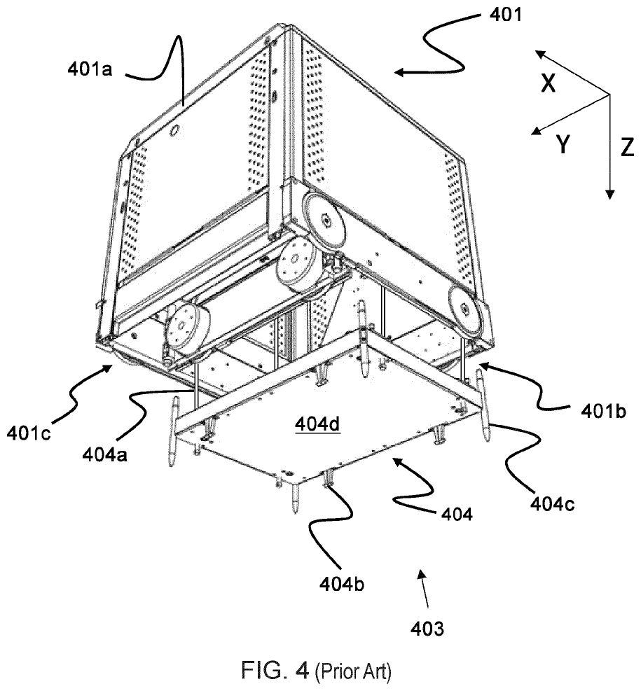

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

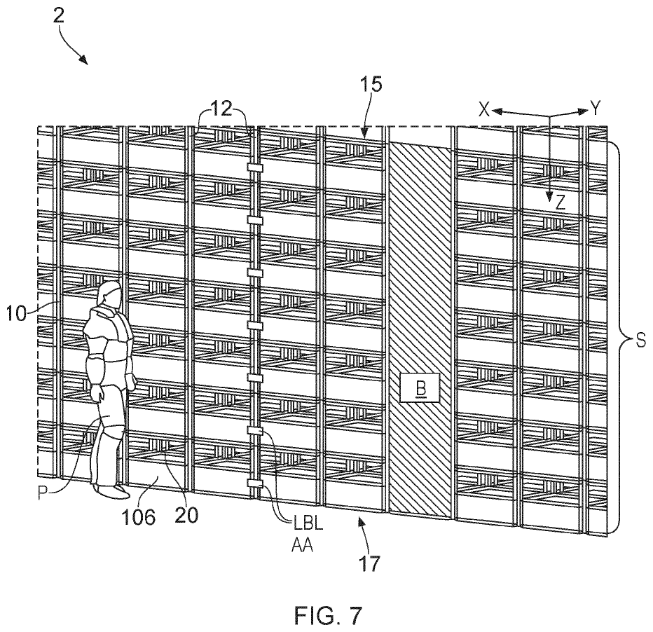

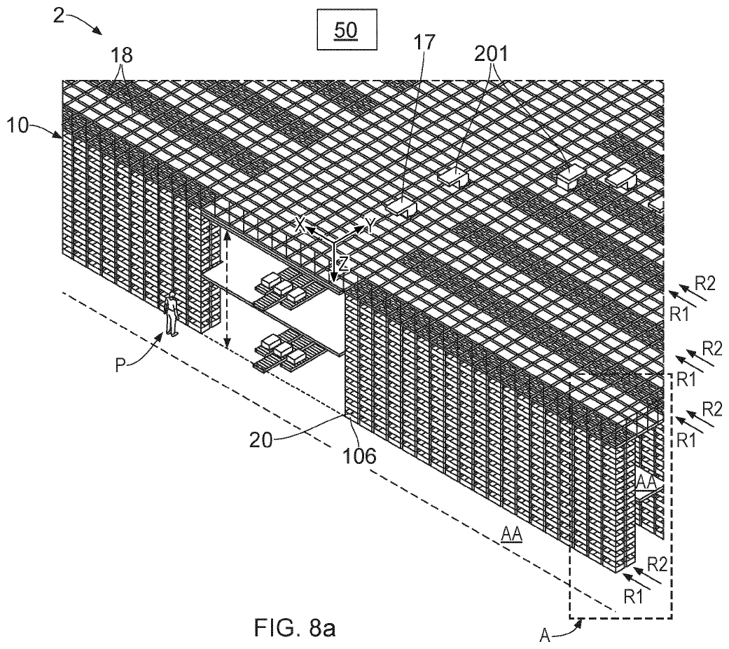

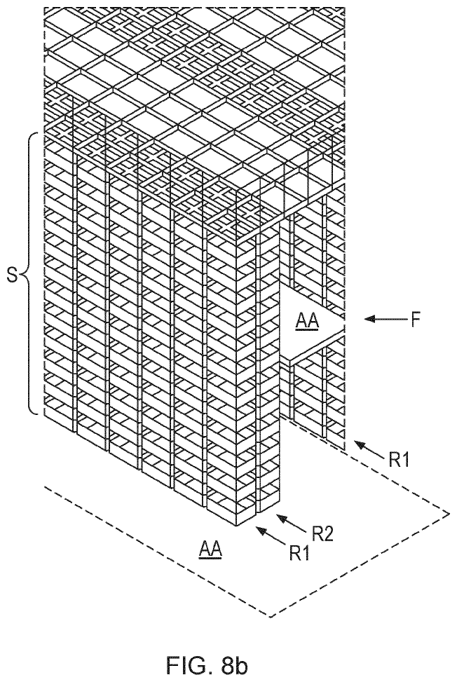

On the right side of FIG. 5, a storage system 2 is shown, indicated as a dashed rectangle. The storage system 2 shown further in detail in FIG. 7 and in FIG. 8a. Here it is shown that the storage system 2 comprises a first structure 10 comprising upright members 12, the upright members defining a volume of columns 15 provided between the upright members 12. Within the columns 15, storage containers can be stacked, as will be described further in detail below.

The storage system 2 further comprises a rail system 18 provided on top of the upright members 12. As shown in FIG. 5, the rail system 18 is provided also on top of the framework structure 100. The storage system 2 further comprises one or more container handling vehicles 201 operating on the rail system 18. The container handling vehicles 201 may be of the prior art type of container handling vehicles, i.e. vehicle 201, 301 and/or 401.

The first structure 10 is in many ways identical to the prior art framework structure 100, in that the upright members 12 may be of the same type as the upright members 102, and further in that the columns 15 are of the same dimension as the storage columns 105. However, there are some differences, which will be described further in detail below.

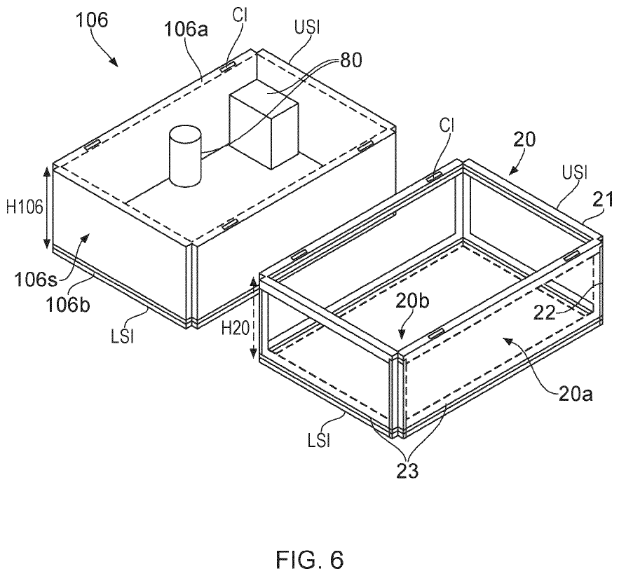

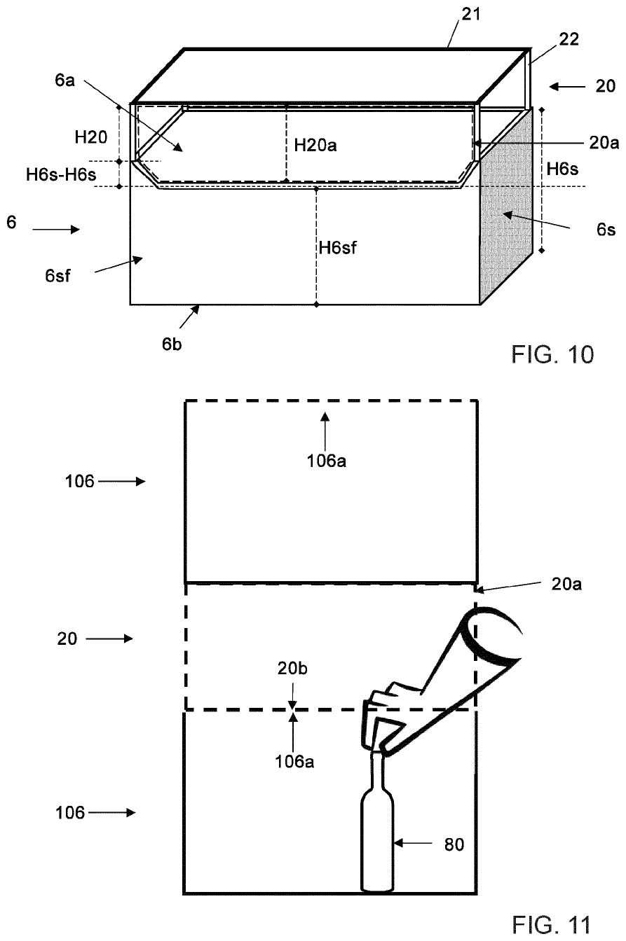

It is now referred to FIG. 6 and FIG. 10, in which two embodiments of a storage container 6, 106 are shown. Both containers 6, 106 are shown to comprise a base 6b, 106b with four sides 6s, 106s protruding upwardly from the base 6b, 106b, wherein a top opening 6a, 106a is defined by an upper edge of the four sides. The top opening 106 is indicated as a dashed rectangle in FIG. 6.

The main difference between the storage container 106 in FIG. 6 and the storage container 6 in FIG. 10 is that the storage container 6 in FIG. 10 has one side 6sf having a height H6sf which is lower than a height H6s of other sides 6s.

In FIG. 6, it is further shown an access frame 20. 4. The access frame 20 comprises a rectangular top portion 21 and legs 22 protruding downwardly from the rectangular top portion 21. In addition, the access frame 20 comprises cross members 23 connected between lower ends of the downwardly protruding legs 22. Hence, in the embodiment of FIG. 6, there are four cross members 23.

The access frame 20 comprises a side opening 20a indicated by a dashed rectangle in FIG. 6. The side opening 20a is defined by the space between the top frame 21, two legs 22 and one cross member 23. The access frame 20 also comprises a bottom opening 20b indicated by a dashed rectangle in FIG. 6. The bottom opening 20b is defined by the space between the lower ends of the downwardly protruding legs 22 together with the cross members 23.

The storage container 6, the storage container 106 and the access frame 20 comprise a connection interface CI provided on their respective upper surfaces, wherein a lifting device 403 of the container handling vehicle 201, 301, 401 comprises a gripper 304, 404 that is configured to engage the connection interface CI such that the container handling vehicle 201; 301; 401 is able to lift the storage container 6, storage container 106 or the access frame 20 using the lifting device 403.

The top portion 21 of the access frame 20 defines an upper stacking interface USI allowing a storage container 6, 106 or other access frames 20 to be stacked above the access frame 20. The lower ends of the downwardly protruding legs 22 together with the cross members 23 define a lower stacking interface LSI allowing the access frame 20 to be stacked above storage containers 6, 106 or other access frames 20.

It should be noted that also the storage containers 6, 106 comprises such upper stacking interfaces USI and lower stacking interfaces LSI. Consequently, the containers 6, 106 and access frame 20 can be stacked above each other in any desired sequence.

It is now referred to FIG. 7. Here it is shown that storage containers 106 and access frames 20 are stacked in stacks 17, wherein each access frame 20 is positioned between two storage containers 106 in each stack. Hence, a bottom (such as the above lower stacking interface LSI) of each access frame 20 is resting on an underlying storage container, and a top (such as the upper stacking interface USI) of the access frame 20 is supporting an overlying storage container 106. In addition, the side opening 20a of each access frame 20 is facing towards a access area AA in which a person P is present. It should be noted that when one access frame 20 is stacked above one container 106 as described above, the bottom opening 20b of each access frame 20 will be aligned with each top opening 106a of each container. Hence, as illustrated schematically in FIG. 11, the person P may reach an item 80 stored in an underlying container 106 by reaching his/her hand in via the side opening 20a through the bottom opening 20b of the access frame 20 and through the top opening 106a of the underlying storage container 106.

The plurality of access frames 20 are arranged in an alternating manner with consecutive storage containers 106, each storage container 106 being spaced from one above by an access frame 20. Hence, a set S, indicated in FIG. 7 as a curly bracket) of accessible storage containers in each stack is achieved, i.e. where access is allowed to each of the underlying storage containers in that set.

In FIG. 7, the set S of accessible storage containers in each stack comprises eight storage containers (i.e. there are eight storage containers each having one access frame 20 stacked on top of itself). It should be noted that in FIG. 7, the person P may need a platform (a stepladder, a ladder etc) in order to be able to access the uppermost storage containers. Hence, depending on a height H106 of the storage container and a height H20 of the access frame 20, the set S of storage containers 106 in one stack may comprise 2-12 storage containers, preferably 3-8 storage containers.

In the embodiment shown in FIGS. 8a and 8b, the set S of storage containers 106 in one stack comprises 12 storage containers.

Hence, the person P may put his/her hand through the side opening 20a, the bottom opening 20b and the top opening 106a and pick the product item 80 directly from the storage container 106.

It should further be noted that in FIG. 7, the side openings 20a of the access frames 20 in each stack is aligned with each other in the vertical direction, i.e. the Z-direction. It should further be noted that the side openings 20a of the access frames 20 are faced towards the access area AA.

It is now referred to FIG. 8a and FIG. 8b. Here, two rows R1, R2 of stacks 17 are indicated. The side openings 20a of the access frames 20 in the first row R1 of stacks 17 are aligned with each other in the horizontal direction X. The side openings 20a of the access frames 20 in the second row R2 of stacks 17 are also aligned with each other in the horizontal X direction. Consequently, the side openings 20a of the access frames 20 in the second row R2 of stacks 17 are parallel with the side openings 20a of the access frames 20 of the first row R1 of stacks 17. In addition, the first row R2 is adjacent to the second row R2 and the side openings 20a of the access frames 20 in the first row R1 are facing away from the side openings 20a of the access frames 20 in the second row R2.

The first row R1 of stacks 17 and the second row R2 of stacks 17 form a shelf-like structure from which the person P may retrieve desired product items 80.

Consequently, the person P may access storage containers 106 in the first row R1 of stacks 17 from one side of the shelf-like structure, while the person P may access storage containers in the second row R2 of stacks 17 from the opposite side of the shelf-like structure. As indicated in FIG. 8b, the access area AA extends to both sides of the two rows R1, R2 of stacks 17. Preferably, as shown in FIG. 8a, there are several such self-like structures, each having two rows R1, R2 of stacks 17, arranged in parallel to each other. In FIG. 8a, it is shown that the access area has a width WPA corresponding to the width of three columns. The width is here measured in the Y-direction, i.e. perpendicular to the X-direction.

It is also shown in FIG. 8a and FIG. 8b that the storage system 2 may comprise multiple floors, as indicated by the floor F, which are also denoted as an access area AA.

It is now referred to FIG. 7. Here it is shown that the system 2 comprises electronic labels LBL secured to the upright members 12. These electronic labels LBL may display information about the products in their adjacent storage container.

It is now referred to FIG. 7. Here the storage system 2 comprises a barrier B for covering at least one of the stacks 17 of storage containers 6, 106 and access frames 20 during elevation of a storage container 6, 106 or access frame 20 from the one stack 17 and/or during lowering of a storage container 6, 106 or access frame 20 into the one stack 17. Hence, the barrier is protecting the person from accessing the storage containers and access frames during vertical movement of the storage containers and access frames. The barrier may be a rolling grille or other type of barrier. The barrier B is typically secured below the rail system 18 or to the upright members 12.

### Operation of the Storage System

The operation of the storage system 2 will now be described. In FIG. 5 it is shown that the storage system 2 comprises a control system 50 for controlling the container handling vehicles, i.e. to control the movement of the desired storage containers from the structure 100 to the structure 10, to control the movement of the access frames 20 above the respective storage containers in the structure 10. The control system 50 may also be configured to control the barrier B when storage containers and access frames are to be retrieved from and/or delivered to the structure 10. The control system 50 may also be configured to update the labels LBL based on the content of the storage containers at the different locations within the structure 10. Typically, the control system 50 will be integrated with, or provided in communication with, the control system 100 (shown in FIG. 1) of the prior art system 1.

In the present example, storage containers 106 of the prior art type are used. However, also storage containers 6 shown in FIG. 10 may also be used.

In the present embodiment, the access area AA is a warehouse where customers have access. The customers may then walk between the rows R1, R2 and retrieve products 80 from the storage containers via the access frames 20. However, the access area AA may also be a restricted area only accessible for persons employed to perform picking operations.

Initially, it is assumed that the first structure 10 is empty, i.e. that no storage containers or access frames are stored within the columns 15 of the first structure 10. This may be necessary for cleaning purposes etc, preferably in the evening after closing of the access area AA.

The control system 50 is then configured to control the container handling vehicle to move a first storage container 106 from the second structure 100 and stack it, i.e. insert it, into one of the storage columns 15 of the first structure 10. Then the container handling vehicle or another container handling vehicle is controlled to stack a first access frame 20 directly above the first storage container 106. In a next step, the container handling vehicle or another container handling vehicle is controlled to stack a second storage container 106 directly above the first access frame 20. In a next step again, the container handling vehicle or another container handling vehicle is controlled to stack a second access frame 20 directly above the second storage container 106.

The above actions are repeated for that stack until a desired height of storage containers and access frames are achieved, and the above actions are repeated for the other stacks in the first structure 10.

As the control system 500 and/or the control system 50 know the content of each storage container, containers containing products of the same category may be stacked above each other or in stacks adjacent to each other in the same row of stacks.

As shown schematically in FIG. 11, a person P is now allowed to reach an item 80 stored in an underlying storage container 106 by reaching in via the side opening 20a through the bottom opening 20b of the access frame 20 and through the top opening 106a of the underlying storage container 106.

By monitoring the number of product items retrieved from the respective storage containers, it is possible to determine if some storage containers are empty or near empty. In such a case, it can be determined that the empty or near empty storage containers are to be replaced by full or near full storage containers. If the storage container is empty, this is preferably done by removing the empty storage container and moving a full or near full storage container from the framework structure 100 to the first structure 10, either to the same location as the empty or near empty storage container or to another location within the first structure 10. If the storage container is near empty, it can be moved to a replenishment station for replenishing.

This can be done during the opening hours of the warehouse. In this case, the barrier B should be applied to the structure 10 to prevent injuries caused by moving containers and access frames within the storage columns 15. Alternatively, this can be done after the opening hours of the warehouse. As no persons are present in this case, no barrier B is required.

### Alternative Embodiments

Some further alternative embodiments will now be described.

Initially, it should be noted that the access frame 20 can be regarded as having two or four side openings, depending on how the columns and stacks are arranged in the first structure 10. The access frame shown in FIG. 6 may be used in both rows R1 and R2 without requiring the access frame to be pivoted 180°.

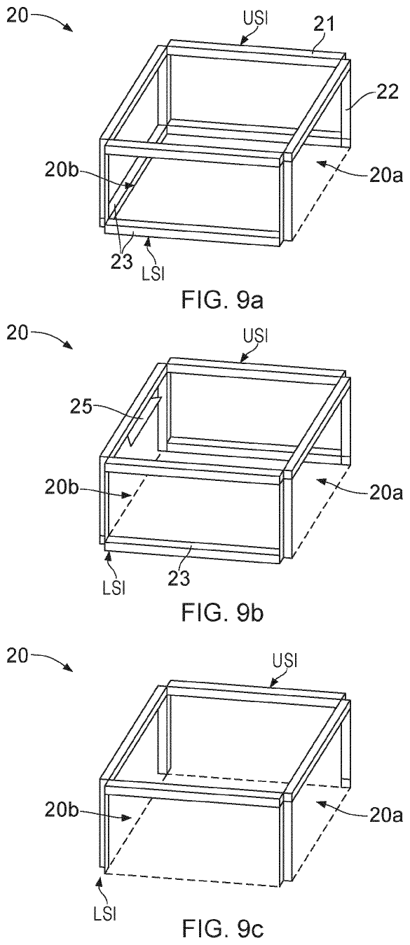

It is now referred to FIG. 9a, in which an alternative embodiment of the access frame 20 is disclosed. Here, the access frame 20 comprises the top portion 21, four legs 22 each leg 22 protruding downwardly from corners of the rectangular top portion 21. Here, there are only three cross members 23 arranged in a U-shaped configuration with its open end facing towards the side opening 20a. Hence, as there is no cross member 23 at the side opening 20a, the upper edge of the storage container is forming the lower part of the side opening 20a. This will increase the area of the side opening 20a without increasing the height H20 of the access frame 20.

It is now referred to FIG. 9b. Here, the access frame 20 comprises the top portion 21, four legs 22 each leg 22 protruding downwardly from corners of the rectangular top portion 21. Here, there are only two cross members 23. It should be noted that this embodiment has the same advantage regarding size of side opening when used in the first row R1 as when used in the second row R2.

It is now referred to FIG. 9c. Here, the access frame 20 comprises four legs 22, each leg 22 protruding downwardly from corners of the rectangular top portion 21. Here, there are no cross members 23.

It should be noted that in the embodiment of FIG. 6, the lower part of the access frame 20 may comprise a rectangular bottom portion secured to the rectangular top portion by means of the legs 22. Also here, the bottom opening 20b is considered to be defined by the lower ends of the downwardly protruding legs 22 together with the cross members 23, as such an access frame 20 will have a side opening 20a and bottom opening 20b identical to the embodiment of FIG. 6.

Hence, the side opening 20a may be further increased without increasing the height H20 of the access frame 20.

It is now referred to FIG. 10. Here, the storage container 6 described above are shown with its side 6sf being lower than other sides 6s. This storage container is preferably used with the access frame of FIG. 9a, 9b or 9c, i.e. without a cross member 23 defining the lower part of the side opening 20a, in order to increase the height of the side opening. The side 6sf is preferably facing the access area AA. In order to be used in both rows R1, R2, the storage container 6 may comprise two such lower sides 6sf.

In the embodiment shown in FIG. 9b, the storage container comprises at least one light 25 to illuminate an interior of a storage container. All embodiments of the storage container may comprise such a light 25. The light is preferably battery-powered.

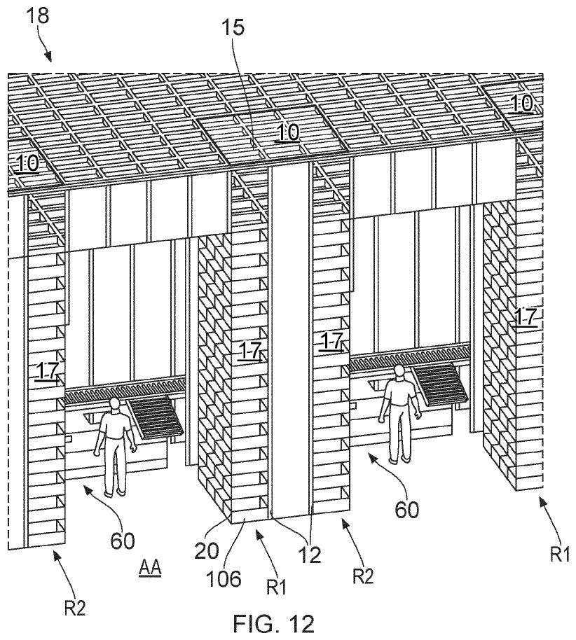

It is now referred to FIG. 12. Here it is shown two access stations 60 and a person operating each access station 60. In this example, the person is performing a picking operation. Facing towards the access station 60 is a number of storage containers 106 and access frames 20 stacked in stacks 17 in columns 15 within a first structure 10. Hence, product items 80 that are picked often may be located in the storage containers 106 of the stacks 17, while other product items 80 are picked from the storage containers transported to and from the access station. As shown in FIG. 12, there are four stacks 17 on each side of the access station 60, i.e. eight stacks in two rows R1, R2 are faced towards the access station 60.

In the preceding description, various aspects of storage system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
6 storage container
6a top opening
6b base
6s sides
6sf front side
10 first structure
12 upright members
15 columns
17 stacks
18 rail system
20 access frame
20a side opening
20b bottom opening
21 top portion
22 legs
23 cross members
25 light
50 control system
60 access station
80 product item
100 framework structure
102 upright members of framework structure
104 storage grid
105 storage column
106 storage container
106′ particular position of storage container
107 stack
108 rail system
110 parallel rails in first direction (x)
112 access opening
119 first port column
120 second port column
201 prior art container handling vehicle
201a vehicle body of the container handling vehicle 201
201b drive means/wheel arrangement/first set of wheels in first direction (x)
201c drive means/wheel arrangement/second set of wheels in second direction (y)
301 prior art cantilever container handling vehicle
301a vehicle body of the container handling vehicle 301
301b drive means/first set of wheels in first direction (x)
301c drive means/second set of wheels in second direction (y)
304 gripping device
401 prior art container handling vehicle
401a vehicle body of the container handling vehicle 401
401b drive means/first set of wheels in first direction (x)
401c drive means/second set of wheels in second direction (y)
404 gripping device
404a lifting band
404b gripper
404c guide pin
404d lifting frame
500 control system
AA access area
CI connection interface
LBL electronic labels
LSI lower stacking interface
R1 first row
R2 second row
USI upper stacking interface
WPA width
X first direction
Y second direction
Z third direction

1.-23. (canceled)

24. A storage system (2) comprising:
a first structure (10) comprising upright members (12), the upright members defining a volume of columns (15) provided between the upright members (12);
a rail system (18) provided on top of the upright members (12); and
a plurality of storage containers (6; 106) arranged in stacks (17) within the columns (15), each storage container (6; 106) having a top opening (6a, 106a); wherein one or more of the stacks (17) includes a plurality of access frames (20), each access frame (20) being positioned between storage containers (6; 106) within that stack, with a bottom of each access frame (20) resting on an underlying storage container (6; 106) and a top of the access frame supporting an overlying storage container (6; 106), each access frame (20) being configured to provide a side opening (20a) and a bottom opening (20b) to allow a person (P) to reach an item (80) stored in an underlying storage container (6; 106) by reaching in via the side opening (20a) through the bottom opening (20b) of the access frame (20) and through the top opening (6a, 106a) of the underlying storage container (6; 106), wherein the plurality of access frames (20) are arranged in an alternating manner with consecutive storage containers (6; 106), each storage container (6; 106) being spaced from one above by an access frame (20), to provide a set of accessible storage containers in that stack where access is allowed to each of the underlying storage containers in that set.

25. The storage system (2) according to claim 1, wherein the storage system (2) comprises a container handling vehicle (201; 301; 401) operating on the rail system (18), wherein the container handling vehicle (201; 301; 401) comprises a lifting device (403) which is configured for vertical transportation of one of the storage containers (6; 106) or the access frames (20) within the storage columns (15) and for horizontal transportation of one of the storage containers (6; 106) or the access frames (20) above the rail system (18).

26. The storage system (2) according to claim 2, wherein the storage containers (6; 106) and the frames (20) each comprise a connection interface (CI) on an upper surface and wherein the lifting device (403) of the container handling vehicle (201; 301; 401) comprises a gripper (304, 404) that is configured to engage the connection interface (CI) such that the container handling vehicle (201; 301; 401) is able to lift any of the storage containers (6; 106) or frames (20) using the lifting device (403).

27. The storage system (2) according to claim 24, wherein the access frame (20) comprises a rectangular top portion (21) and legs (22) protruding downwardly from the rectangular top portion (21), wherein the top portion (21) defines an upper stacking interface (USI) allowing a storage container (6; 106) to be stacked above the access frame (20).

28. The storage system (2) according to claim 27, wherein the side opening (20a) is defined by an area between one side of the rectangular top portion (21) and two of the downwardly protruding legs (22).

29. The storage system (2) according to claim 27, wherein the bottom opening (20b) is defined by an area between the lower end of the downwardly protruding legs (22).

30. The storage system (2) according to claim 27, wherein the access frame (20) comprises cross members (23) connected between lower ends of at least some of the downwardly protruding legs (22), wherein the bottom opening (20b) is defined by the lower ends of the downwardly protruding legs (22) together with the cross members (23).

31. The storage system (2) according to claim 30, wherein the access frame (20) comprises three cross members (23) arranged in a U-shaped configuration with its open end facing towards the side opening (20a).

32. The storage system (2) according to claim 27, wherein lower ends of the downwardly protruding legs (22) defines a lower stacking interface (LSI) allowing the access frame (20) to be stacked above storage containers (6; 106) or other access frames (20).

33. The storage system (2) according to claim 24, wherein access frames (20) are stacked alternately with storage containers in one or more of the stacks (17), optionally all of the stacks, along one side of a volume defined by the structure.

34. The storage system (2) according to claim 24, wherein side openings (20a) of access frames (20) in a first row (R1) of stacks (17) are aligned with each other in a horizontal direction (X).

35. The storage system (2) according to claim 34, wherein the side openings (20a) of access frames (20) in the first row (R1) of stacks (17) are facing a access area (AA) which is accessible for a person (P).

36. The storage system (2) according to claim 24, wherein each storage container (6; 106) comprises a base (6s; 106s) with four sides (6s; 106s) protruding upwardly from the base (6b, 106b), wherein the top opening (6a; 106a) is defined by an upper edge of the four sides.

37. The storage system (2) according to claim 35, wherein one side (6sf) of the storage container (6) has a height (H6sf) which is lower than a height (H6s) of other sides (6s), and wherein the one side (6sf) of the storage container (6) is aligned with the side opening (20a) when an access frame (20) is stacked above the storage container (6).

38. The storage system (2) according to claim 37, wherein the one side (6sf) of the storage container (6) is facing the access area (AA).

39. The storage system (2) according to claim 34, wherein side openings (20a) of access frames (20) in a second row (R2) of stacks (17) are parallel with the first row (R1) of stacks (17), wherein the first row (R2) is adjacent to the second row (R2) and wherein the side openings (20a) of the access frames (20) in the first row (R1) are facing away from the side openings (20a) of the access frames (20) in the second row (R2).

40. The storage system (2) according to claim 39, wherein the side openings (20a) of the access frames (20) in the second row (R2) of stacks (17) are facing the access area (AA) to provide access for a person (P).

41. The storage system (2) according to claim 24, wherein the access frame (20) comprises at least one light (25) to illuminate an interior of a storage container (6, 106).

42. The storage system (2) according to claim 24, wherein the storage system (2) comprises a barrier (B) for covering at least one of the stacks (17) of storage containers (6, 106) and access frames (20) during elevation of a storage container (6, 106) or access frame (20) from the one stack (17) and/or during lowering of a storage container (6, 106) or access frame (20) into the one stack (17).

43. The storage system (2) according to claim 24, storage system (2) comprises:
a second structure (100) comprising upright members (102), the upright members (102) defining a volume of columns (105) provided between the upright members (102);
a plurality of storage containers (6; 106) stacked directly above each other in stacks (107) within the columns (105);
wherein the second structure (100) is provide adjacent to the first structure (10); wherein the rail system (18) is provided on top of the upright members (102).

44. A method for making product items (80) stored in storage containers (6; 106) accessible to a person (P), wherein the method comprises the steps of:
stacking a first storage container (6; 106) into a column (15) defined by upright members (12) of a first structure (10);
stacking a first access frame (20) directly above the first storage container (6; 106);
stacking a second storage container (6; 106) directly above the first access frame (20);
stacking a second access frame (20) directly above the second storage container (6; 106);
allowing a person (P) to reach an item (80) stored in an underlying storage container (6; 106) by reaching in via the side opening (20a) through the bottom opening (20b) of the access frame (20) and through the top opening (6a, 106a) of the underlying storage container (6; 106).

45. The method according to claim 44, wherein the steps of stacking comprises the step of:
controlling a container handling vehicle (201, 301, 401) to move horizontally on a rail system (18) secured above the upright members (12);
controlling a lifting device (304, 404) of the container handling vehicle (201, 301, 401) to stack the storage containers (6; 106) and the access frames (20) into the first columns (15).

46. The method according to claim 45, the method further comprises the step of:
controlling the container handling vehicle to retrieve storage containers and/or access frames stored in stacks (107) within columns (105) of a second structure (100) located below the rail system (18).
